(19) United States
(12) Patent Application Publication
(10) Pub. No.: US 2017/0102252 A1
(43) Pub. Date: Apr. 13, 2017

(54) ELECTROMAGNETIC FLOW METER

(71) Applicant: TECHCROSS, INC., Seoul (KR)

(72) Inventors: KYUWON PARK, Seoul (KR); SEONGTAE KIM, Seoul (KR); HAIDON LEE, Seoul (KR); GWANGHO LEE, Seoul (KR)

(21) Appl. No.: 15/241,329

(22) Filed: Aug. 19, 2016

(30) Foreign Application Priority Data
Aug. 26, 2015 (KR) 10-2015-0119970

(51) Int. Cl. G01F 1/58

(52) U.S. Cl. CPC G01F 1/588

(57) ABSTRACT

Provided is an electromagnetic flowmeter, including: a coil configured to form a magnetic field as power is applied; an electrode configured to measure an electromotive force generated according to a flow rate passing through the magnetic field; an amplifying circuit unit configured to amplify the electromotive force measured at the electrode; and a relay unit that is provided between the electrode and the amplifying circuit unit and that is turned on or off.

### CROSS-REFERENCE TO RELATED APPLICATION

The instant application claims priority to Korean Patent Application Ser. No. 10-2015-0119970, filed Aug. 26, 2015, the entire specification of which is expressly incorporated herein by reference.

### FIELD OF THE INVENTION

The present disclosure relates to an electromagnetic flow meter, and more particularly, to an electromagnetic flow meter that is capable of preventing an external high voltage shock due to thunderstroke or welding.

### BACKGROUND OF THE INVENTION

An electromagnetic flow meter means a flow meter using an electromagnetic induction, that measures a flow based on a principle that an electromotive force proportional to a flow rate occurs in an electrode perpendicular to both of a nonmagnetic pipe and a conductive fluid due to an electromagnetic induction, when a voltage is applied so that a magnetic field is formed in perpendicular to the nonmagnetic pipe, and the conductive fluid is discharged.

FIG. 1 is a diagram illustrating a configuration of a general electromagnetic flowmeter.

Referring to FIG. 1, the electromagnetic flowmeter 10 is mounted in one side of a pipe 11 in which a fluid flows, that is configured to include a plurality of electrodes 12 that are installed on the pipe 11, and a coil 13 that is disposed around the pipe 11.

When a conductive fluid flows with a flow rate υ in the pipe 11, an electromotive force E may occur in the electrode 12 installed in the pipe 11, and, as the E is proportional to an average flow rate, when the E is amplified and recorded, the change in the flow rate can be seen continuously.

E=Bdυ×10⁻⁸

where, E: electromotive force [V], B: magnetic flux density [G], d: inner diameter of pipe [cm], and υ: flow rate [cm/s]

The electromotive force is generated normally with the level of 1 mV and be amplified to process. In this case, typically, an operational amplifier (hereinafter referred to as “OP AMP”) is used as an amplifier circuit. By altering some elements, such as a resistor, a capacitor, a diode, and the like, connected to an external circuit of the operational amplifier, various linear or non-linear operations can be performed stably.

Because the pressure loss scarcely exits and the accuracy and the precision are high, such an electromagnetic flowmeter is widely used in various fields. However, because a semiconductor device that is sensitive to a voltage/current is used in order to achieve the accuracy, it is vulnerable to an external noise or shock. In particular, when the electromagnetic flowmeter is installed in a ship or a plant, it is exposed to a high-voltage shock such as thunderstroke or welding.

Because the OP AMP included in the electromagnetic flowmeter is configured by a transistor (TR) or a field effect transistor (FET), when a shock such as a noise or a high voltage is applied to an input side, there is a problem in that the probability of malfunction occurrence is increased.

In addition, an electrode and a coil configuring the electromagnetic flowmeter are connected to a body of the electromagnetic flowmeter to be mounted on the pipe. Because the pipe is normally configured by an iron that is a conductive material and the body of the electromagnetic flowmeter is composed of a ferro-alloy such as SUS, the shock of a thunderstroke or a welding is transmitted well through the pipe. Thus, the shock that is transmitted to the electrode and the coil through the pipe is transmitted to a circuit of the electromagnetic flowmeter such that a defect in the electromagnetic flowmeters occurs.

### SUMMARY OF THE INVENTION

The present disclosure has been made in view of the above problems, and provides an electromagnetic flowmeter that enables to protect an internal circuit of the electromagnetic flowmeter regardless of an external shock or noise such as a thunderstroke or a welding.

In accordance with an aspect of the present disclosure, an electromagnetic flowmeter includes: a coil configured to form a magnetic field as power is applied; an electrode configured to measure an electromotive force generated according to a flow rate passing through the magnetic field; an amplifying circuit unit configured to amplify the electromotive force measured at the electrode; and a relay unit that is provided between the electrode and the amplifying circuit unit and that is turned on or off.

### BRIEF DESCRIPTION OF THE DRAWINGS

The objects, features and advantages of the present disclosure will be more apparent from the following detailed description in conjunction with the accompanying drawings, in which:

FIG. 1 is an illustrative schematic diagram depicting a configuration of a general electromagnetic flowmeter;

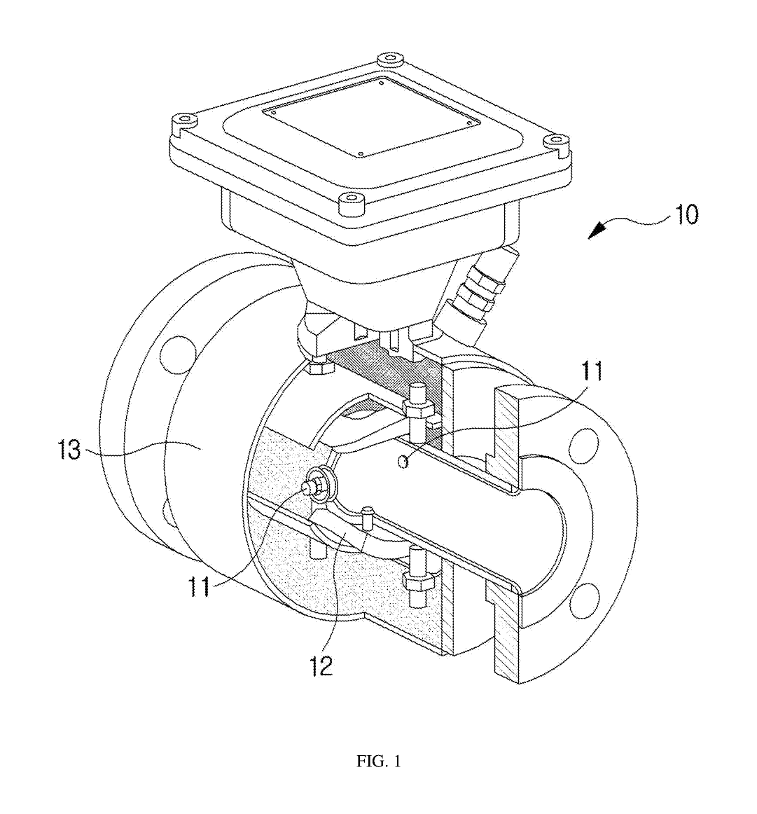

FIG. 2 is an illustrative block diagram depicting an exemplary relay unit and amplifying circuit unit included in an electromagnetic flowmeter, according to a first embodiment of the present disclosure;

FIG. 3 is an illustrative flowchart depicting an exemplary operation of an electromagnetic flowmeter, according to a second embodiment of the present disclosure;

FIG. 4 is an illustrative flowchart depicting an exemplary operation of an electromagnetic flowmeter, according to a third embodiment of the present disclosure;

FIG. 5 is an illustrative flowchart depicting an exemplary operation of an electromagnetic flowmeter, according to a fourth embodiment of the present disclosure; and

FIG. 6 is an illustrative flowchart depicting an exemplary operation of an electromagnetic flowmeter, according to a fifth embodiment of the present disclosure.

### DETAILED DESCRIPTION OF THE INVENTION

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

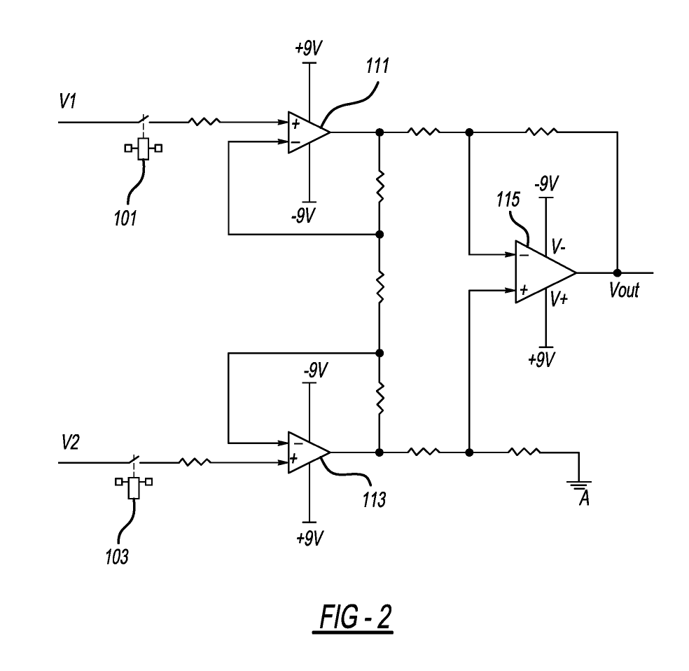

FIG. 2 is a block illustrating a relay unit (e.g., one or more) and an amplifying circuit unit (e.g., one or more) included in an electromagnetic flowmeter according to an embodiment of the present disclosure. As shown in FIG. 2, the electromagnetic flowmeter according to an embodiment of the present disclosure may include a coil (not shown) that forms a magnetic field as a power is applied, an electrode (not shown) that measures an electromotive force that is generated according to the flow rate passing through the magnetic field, relay units 101, 103 that are turned on or off (ON/OFF) according to a control signal, and a plurality of amplifying units 111, 113, 115 that amplifies a signal input from an input end connected to the electrode (not shown), such that an amplified signal (Vout) is outputted through an output end.

The relay unit included in the electromagnetic flowmeter may be provided between the electrode (not shown) and the amplifying circuit unit, and may include a first relay unit 101 and a second relay unit 103. The first relay unit 101 and the second relay unit 103 may be connected to electrodes V1 and V2 respectively. Each electrode may be installed on the pipe in which a fluid flows and may measure a voltage value that is changed according to the flow rate.

The relay units 101, 103 included in the electromagnetic flowmeter according to an embodiment of the present disclosure may connect a signal inputted from the electrode (not shown) to the amplifying circuit unit, and may serve to protect an OP AMP connected to the electrode and a peripheral circuit.

That is, in the case of the electromagnetic flowmeter installed in a ship, because it may be exposed to a noise such as a thunderstroke stroke or a welding, it is possible to prevent the noise signal inputted from the electrode (not shown) when the relay units 101, 103 maintains an OFF state at the time when a probability of the occurrence of the thunderstroke or the welding is high. The time when a probability of the occurrence of a noise is high is usually the time when the ship sails or is under repair such that the electromagnetic flowmeter is not used.

Therefore, only when the electromagnetic flowmeter is actually used, relay units 101, 103 may maintain the ON state to connect the electrode and the amplifying circuit unit. On the other hand, when the electromagnetic flowmeter is not used, the relay units 101, 103 may be turned off so that it is possible to significantly reduce the defects that may be generated in the electromagnetic flowmeter.

Here, after the relay units 101, 103 between the electrode (not shown) and the amplifying circuit unit are turned off, the electromotive force may be measured to correct a zero point of the electromagnetic flowmeter. That is, when the relay units 101, 103 are turned off, only the offset value of the amplifying circuit unit is measured, so that it is possible to correct the error caused by the resistance value of the amplifying circuit unit.

Meanwhile, another embodiment of the present disclosure may provide an electromagnetic flowmeter that includes a coil that forms a magnetic field as a power is applied, an electrode that measures an electromotive force that is generated according to the flow rate passing through the magnetic field, a coil driving unit that drives the coil, and a relay unit that is installed between the coil and the coil driving unit and that is turned on or off. In this case, it is possible to prevent the noise caused by a thunderstroke or a welding from flowing into the coil driving unit through the coil by turning the relay unit on/off.

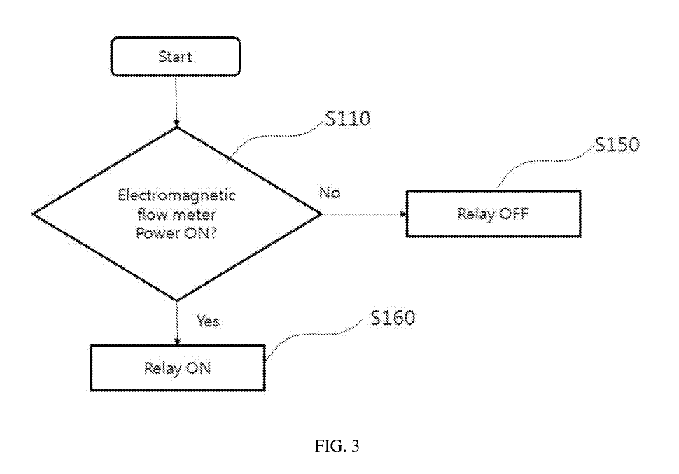

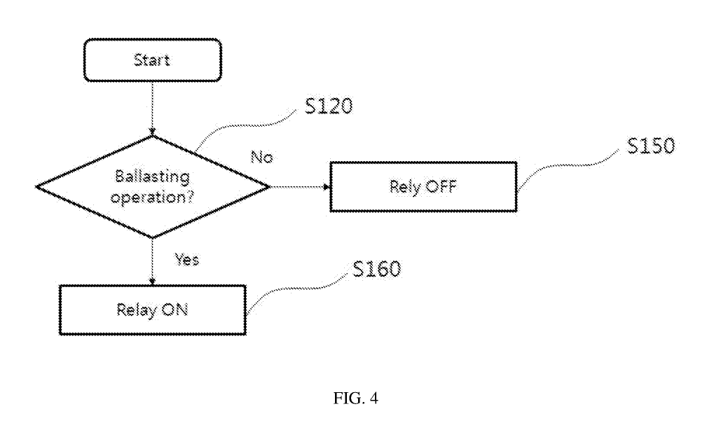

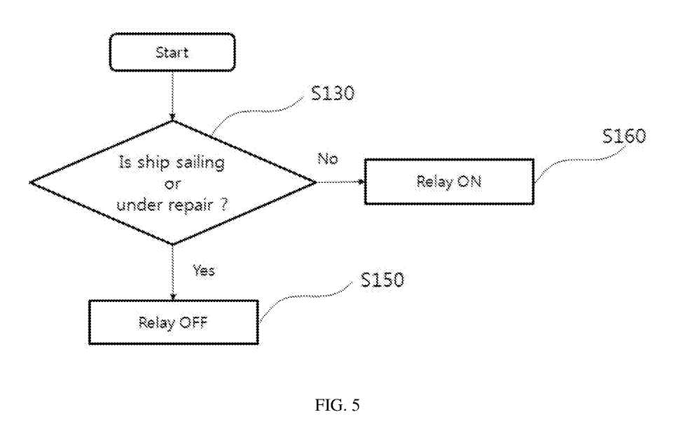

FIG. 3 is a flowchart illustrating an operation of an electromagnetic flowmeter according to an embodiment of the present disclosure, FIG. 4 is a flowchart illustrating an operation of an electromagnetic flowmeter according to another embodiment of the present disclosure, and FIG. 5 is a flowchart illustrating an operation of an electromagnetic flowmeter according to still another embodiment of the present disclosure.

Referring to FIGS. 3-5, the electromagnetic flowmeter according to embodiments of the present disclosure may be configured to turn the relay unit on/off according to a specific condition.

FIG. 3 discloses an operation of turning the relay unit on/off according to the power state of the electromagnetic flowmeter. First, it is determined whether the power of the electromagnetic flowmeter is turned on (S110), and turns the relay unit on when the power of the electromagnetic flowmeter is turned on (S160), and turns the relay unit off when the power of the electromagnetic flowmeter is not turned on (S150).

Here, the relay units 101, 103 may select a normal open type such that the switch of the relay unit is turned off when the electromagnetic flowmeter is turned off. In this case, the relay unit may operate according to the state of the power without the need of a separate control signal. In addition, a controller for controlling the power of the electromagnetic flowmeter to be turned on/off may be separately provided to control the power of the electromagnetic flowmeter. In this case, the controller generates an on/off control signal so that the power of the electromagnetic flowmeter is turned off when the ship sails or is under repair, and the power of the electromagnetic flowmeter is turned on when the ship performs a ballasting operation. Then, the relay units 101, 103 receive the generated control signal and the relay units 101, 103 are turned on/off according to the control signal.

Meanwhile, the relay units 101, 103 may be controlled from the outside by a control signal to turn the relay unit on/off regardless of the state of the power. In this case, the control signal, i.e., an on/off control signal may be transmitted by using a wireless communication method, for example, a short-range wireless communication such as Wi-Fi, BLUETOOTH and/or the like. Further, the control signal may be transmitted through a wire. In this case, it is possible to generate a on/off control signal through a dry contact switch.

For example, the relay units 101, 103 may be controlled to be turned on by giving a command in a wireless communication or generating a control signal by turning the dry contact switch on in order to measure the electromagnetic flowmeter in equipment for monitoring the electromagnetic flowmeter at the time when the electromagnetic flowmeter is to be measured.

The dry contact switch may be wired to be always turned on, and in this case, like a normal electromagnetic flowmeter, the measurement starts when power is turned on, and it operates in the same manner as the method of operating the relay units 101, 103 according to the state of power as described above.

FIG. 4 and FIG. 5 illustrate an operation of controlling the relay units 101, 103 by a control signal. FIG. 4 illustrates an operation of the relay units 101, 103 according to the ballasting operation. That is, it is determined whether the ballasting operation is being performed (S120), and a controller (not shown) generates a control signal that turns the relay unit on when the ballasting operation is being performed (S160), and that turns the relay unit off when the ballasting operation is not being performed (S150). Because the electromagnetic flowmeter should be operated during the ballasting operation, the controller (not shown) generates a control signal to turn the relay unit on when the ballasting operation is being performed.

Meanwhile, in FIG. 5, it is determined whether the ship is sailing or is under repair (S130), and, when the ship sails or is under repair, the probability of the occurrence of the noise is high and the electromagnetic flowmeter is not used, the relay unit is controlled to be turned off (S150), and, when the ship does not sail or is not under repair, the relay unit is controlled to be turned off (S160).

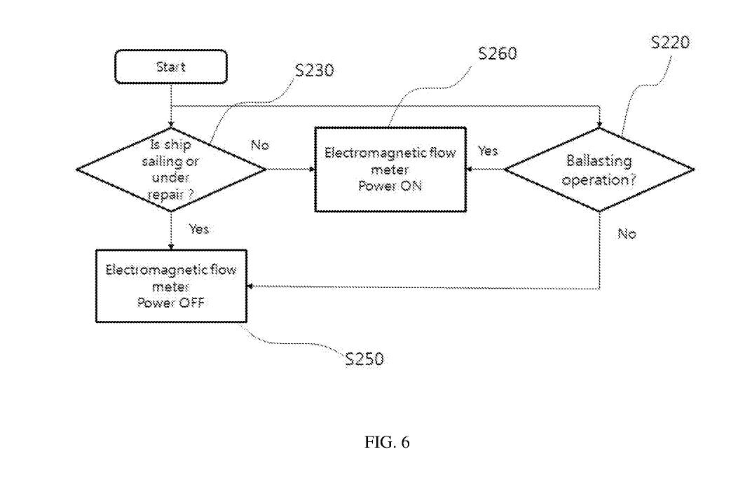

FIG. 6 is a flowchart illustrating an operation of an electromagnetic flowmeter according to still another embodiment of the present disclosure. In the still another embodiment of the present disclosure shown in FIG. 6, the relay unit may be excluded from the configuration of the electromagnetic flowmeter. That is, the still another embodiment of the present disclosure is configured to control the power of the electromagnetic flowmeter only depending on whether a certain condition is satisfied regardless of the existence of the relay unit.

In this embodiment, it is determined whether the ship is sailing or is under repair (S230), and based on the determination result, the power of the electromagnetic flowmeter is controlled to be turned on (S260), or turned off (S250).

In addition, it is determined whether the ballasting operation is being performed (S220), and based on the determination result, the power of the electromagnetic flowmeter is controlled to be turned on (S260), or turned off (S250).

Such an on/off control method may be achieved with a controller for generating an on/off control signal, and may be configured to transmit a control signal generated through the above-described wireless communication method or a wired communication method to a power supply unit of the electromagnetic flowmeter.

According to the present disclosure, a relay unit is provided to be controlled to be turned on/off according to the need so that it is possible to protect the internal circuit of the electromagnetic flowmeter.

In addition, according to the present disclosure, a controller is provided to control the power of the electromagnetic flowmeter to be turned on/off according to the need so that it is possible to protect the internal circuit of the electromagnetic flowmeter.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An electromagnetic flowmeter, comprising:
a coil configured to form a magnetic field as power is applied;
an electrode configured to measure an electromotive force generated according to a flow rate passing through the magnetic field;
an amplifying circuit unit configured to amplify the electromotive force measured at the electrode; and
a relay unit that is provided between the electrode and the amplifying circuit unit and that is turned on or off.

2. The electromagnetic flowmeter of claim 1, wherein the relay unit is turned on or off according to a control signal, and the control signal is generated through a wireless communication or a dry contact switch.

3. The electromagnetic flowmeter of claim 1, wherein the relay unit is turned on when the power of the electromagnetic flowmeter is turned on, and is turned off when the power of the electromagnetic flowmeter is turned off.

4. The electromagnetic flowmeter of claim 2, wherein the control signal is generated as an off-signal when a ship sails or is under repair, and is generated as an on-signal when the ship performs a ballasting operation.

5. The electromagnetic flowmeter of claim 3, further comprising a controller that controls the power of the electromagnetic flowmeter to be turned off when a ship sails or is under repair, and controls the power of the electromagnetic flowmeter to be turned on when the ship performs a ballasting operation.

6. The electromagnetic flowmeter of claim 1, wherein a zero point correction is performed when the relay unit is turned off.

7. An electromagnetic flowmeter, comprising:
a coil configured to form a magnetic field as power is applied;
an electrode configured to measure an electromotive force generated according to a flow rate passing through the magnetic field;
a coil driving unit configured to drive the coil; and
a relay unit that is provided between the coil and the coil driving unit and that is turned on or off.

8. The electromagnetic flowmeter of claim 7, wherein the relay unit is turned on or off according to a control signal, and the control signal is generated through a wireless communication or a dry contact switch.

9. The electromagnetic flowmeter of claim 7, wherein the relay unit is turned on when the power of the electromagnetic flowmeter is turned on, and is turned off when the power of the electromagnetic flowmeter is turned off.

10. The electromagnetic flowmeter of claim 8, wherein the control signal is generated as an off-signal when a ship sails or is under repair, and is generated as an on-signal when the ship performs a ballasting operation.

11. The electromagnetic flowmeter of claim 9, further comprising a controller that controls the power of the electromagnetic flowmeter to be turned off when a ship sails or is under repair, and controls the power of the electromagnetic flowmeter to be turned on when the ship performs a ballasting operation.

12. An electromagnetic flowmeter, comprising:
a coil configured to form a magnetic field as power is applied;
an electrode configured to measure an electromotive force generated according to a flow rate passing through the magnetic field;
an amplifying circuit unit configured to amplify the electromotive force measured at the electrode; and
a controller that controls the power of the electromagnetic flowmeter to be turned off when a ship sails or is under repair, and controls the power of the electromagnetic flowmeter to be turned on when the ship performs a ballasting operation.
